(19) United States
(12) Patent Application Publication
(10) Pub. No.: US 2003/0088434 A1
(43) Pub. Date: May 8, 2003

(54) Web-based clinical, cross-organizational management information system & method of centralizing & coordinating treatment referrals for persons in need of supervision

(76) Inventor: Elaine Blechman, Boulder, CO (US)

Correspondence Address: Eugene Lieberstein, 2151 Long Ridge Road, Stamford, CT, 06903, US

(21) Appl. No.: 10/210,127

(22) Filed: Aug. 1, 2002

Related U.S. Application Data
(60) Provisional application No. 60/309,334, filed on Aug. 2, 2001.

(51) Int. Cl. G06F 17/60

(52) U.S. Cl. 705/1

(57) ABSTRACT

A Web-based Clinical, Cross-Organizational Management Information integrated computer based system and method of centralizing and coordinating the reporting, identification, and treatment of referrals for persons in need of supervision via the internet including: a centralized database for storing a list of specified persons currently in treatment by a caregiver affiliated with a member alliance of caregiver organizations and for storing other information and data relative to each such person; a web server for controlling the interface with authorized users of the system affiliated with said member alliance and for screening the PIN numbers of the authorized users before approving access to the system; communication means through which the authorized users communicate to said web server; and toolbox means for requesting and receiving information from said authorized users with said toolbox means including means for generating an informational reminder to a selected authorized user to remind such user to carry out a specific function and to update the centralized database with a report; and an e-mail server for processing and sending an e-mail message to the selected authorized user corresponding to the informational reminder.

### FIELD OF THE INVENTION

The present invention is a Web-based Clinical, Cross-Organizational Management Information integrated computer based system (hereinafter “System”) and method (hereinafter “Method”) of centralizing and coordinating the reporting, identification, and treatment referrals of Persons In Need Of Supervision, hereinafter referred to as clients.

Persons in Need of Supervision. A person in need of supervision is an individual of any age who warrants caregiver coordinated supervision, treatment, and care given evident risk for behavior harmful to self or others. The purpose of supervision is to promote the client's round-the-clock involvement in personally meaningful prosocial activities that cause no harm to self or others including school and work attendance, health-enhancing activities, and prescribed medical regimens. Person in a wide range of groups and categories need the more active supervision available with the systems described herein. Examples of appropriate individuals include juvenile offenders, adult offenders on probation or parole, demented adults, individuals with various developmentally disabilities, suicidal individuals, abusive and neglectful parents, individuals with mental illness, individuals whose health depends upon compliance with a complicated medical or psychiatric treatment regimen, employees requiring assistance with mental health, drug or alcohol problems. Persons in need of supervision also include healthy children and adolescents whose parents want help in supervising their daily schedule of activities.

Objectives. The objectives of the System and Method of the present invention are to enhance individual and public safety by significantly improving the standard of care and support of persons in need of supervision above contemporary practice, and to retain these individuals in their own homes, schools, work sites, and communities without hospitalization, institutionalization, imprisonment, or residential detention. Another objective of the present invention is to provide a Web-based method of centralizing and coordinating the identification, treatment referrals, and reporting of persons in need of supervision within and/or across a community, school system, court system, corporation, agency, facility, institution, cross-organization alliance, or treatment network.

System functions. The System accomplishes its objectives through a variety of functions listed on p. 8.

Subscriptions. Users of the System will purchase subscriptions to access its services. An individual subscription enables one client to be supervised, by one or more caregivers, using the System's Methods for a specific period of time. Subscriptions may be group or individually based.

Group subscriptions. A Group Subscriber holds multiple individual subscriptions to the System. The System may be the generic version or one customized to the Group Subscriber's unique needs. Examples of Group Subscribers would include a state or municipality; public or private social service or mental health agency; public or private school system; residential detention, treatment, or incarceration facility; prison; corporation; employee assistance plan; health-maintenance organizations, preferred provider organization. A Group Subscriber and its Authorized Users ordinarily have access only to its System and not to other Group Subscribers' Systems.

Initiation of the Group Subscriber's System Version includes the following steps:

Define organizational members of the Group Subscriber's network or alliance of caregivers, hereinafter referred to as a Caregiver Alliance. Caregiver Alliance Members may be units of one entity (e.g., departments within a school system) or they may be separate entities (e.g., school system, police, juvenile justice system).

Develop a strategic plan for collaboration among Caregiver Alliance Members and achievement of Caregiver Alliance Goals.

Agree to protect the privacy, confidentiality, and security of all collected information.

Appoint a Group Subscriber Assessment Coordinator

Appoint a Group Subscriber Intervention Coordinator

Appoint a Group Subscriber System Manager

Establish procedures for obtaining informed assent and consent from clients of any age and, as appropriate, from their parents or legal guardians

Agree to follow applicable HIPAA requirements such as collaboration, security, and privacy Define Authorized Users of the System to whom passwords with varying levels of access will be issued

Define aspects of the System available to Public Users

Enter information about clients receiving care, supervision, or treatment into a Client Database

Enter information about the schedules and expertise of caregivers (e.g., social worker, psychotherapist, physician, physical therapist, probation officer, parole officer) who provide care, supervision, and treatment into a Caregiver Database

Enter information about the schedules and chain of command for managers and supervisors of caregivers into a Management Database

Individual subscribers. An Individual Subscription allows the System to be used to coordinate the activities of a single client's caregivers. Examples of Individual Subscribers include a parent, guardian, or other individual responsible for the care of the client. Individual Subscribers, linked to a Group Subscriber's System Version, are hereinafter referred to as Group Plan Subscribers. Free-Agent Subscribers, have no links to a Group Subscriber's System Version and use a specially designed version of the System, Free Agents' System.

Initiation of Individual Subscriptions. Initiation of Group Plan Subscriptions is facilitated by the Group Subscriber. Initiation of Free Agent Subscriptions is the responsibility of the Individual Subscriber. In either case, subscription initiation involves these steps:

Enter information about clients receiving care, supervision, or treatment into a Client Database

Provide identifying information for the client's Lead Caregiver and Caregiver Team Members (e.g., parents, social worker, teacher, religious leader).

Provide, from the appropriate individuals, informed assent and/or consent to the formation and operation of the Caregiver Team and to sharing of client information among Caregiver Team members.

Caregiver Team Members agree to follow applicable HIPAA requirements such as collaboration, security, and privacy.

Caregiver Team develops a Behavioral Contract for collaborative supervision, treatment, and care of the client by the Caregiver Team.

Caregiver Team defines the responsibilities of each Team Member for given aspects of the Behavioral Contract.

Caregiver Team establishes, as appropriate, incentives motivating adherence to contract responsibilities by the client and by Caregiver Team Members.

Caregiver Team establishes procedures for preventing crises due to poor adherence to contract responsibilities by the PIN and by Caregiver Team Members.

### BACKGROUND OF THE INVENTION

From 12-25% of American youths ages 5 to 19 are at risk for behavior harmful to themselves and others including violence, crime, substance abuse, and suicide. All youths are vulnerable to exploitation particularly by unscrupulous peers and adults. Inadequate supervision, insufficient exposure to prosocial activities and insufficient coordination of caregivers are the best predictors of exploitation and harmful youth behavior. All parents need help keeping their children out of harm's way while coordinating and overseeing services children receive from schools, health and mental-health practitioners, community agencies and residential facilities. Front line-caregivers need help in tracking their minor clients, sharing information about their educational, medical, and mental-health treatment status, their schedules, goals, and daily activities, and coordinating action with parents and other caregivers.

At least 12% of the adult population includes Persons In Need of Supervision. Given past behavior or current disabilities, these individuals are at risk for behavior harmful to self or others and for engaging in Risk-Related Incidents. Corporations, correctional systems, employee assistance plans, health maintenance organizations, preferred provider organizations need a clinical, cross-organizational management information system pertinent to the care of Persons In Need of Supervision.

State and federal legislation requires public school systems to implement strategic plans for early identification and interception of students at risk for acts of violence. Similarly, federal and state governments encourage municipalities to implement strategic plans for early identification and interception of domestic terrorists. Both state and federal agencies (such as the post office) and private corporations need strategic plans for preventing workplace violence on the part of impulsive, angry individuals. Meaningful formulation and implementation of strategic plans for preventing harmful behavior, requires a vortex of information about early signs of potentially harmful behavior from the widest variety of informants.

Unique nature of present invention. No multi-functional clinical, cross-organizational management information system and method exists for Persons In Need of Supervision other than the system and method of the present invention. No alternative system has the functionality of the present invention. The list of multiple functions integrated by the present invention appears on page 8. Other inventions bear on a subset of these functions. Thus, an ankle bracelet with a global position system provides a means of tracking the physical whereabouts of parolees, but nothing more.

Shortcomings of the conventional approach. In the conventional approach, mental health, social service, law enforcement, substance abuse, youth and adult correction “caregiver agencies” in the same community operate in insular, uncoordinated, and redundant ways. The conventional approach endangers the health, safety, and human rights of Persons In Need of Supervision and the public safety by neglecting or failing to integrate the multiple functions of the present invention. For example:

Regarding reporting of risk-related incidents, the conventional approach fails to inform community members about what constitutes a risk-related incident and fails to provide a convenient means of reporting potential risk-related incidents to qualified professionals with the means of taking appropriate action.

Regarding identification of Persons In Need of Supervision, the conventional approach does not create an information vortex, coordinating in one database information about each PIN's involvement in various risk-related incidents. For example, in the case of the Columbine High School shootings, bits of information available to various community members about Klebold and Harris' threats of violence and involvement in risk-related incidents were never collated and used to coordinate preventative action.

Regarding treatment referral, a PIN who has committed a risk-related incident and requires a treatment referral, is often placed on waiting list for supervision and treatment despite imminent risk for behavior harmful to self or others. For example, after a mentally ill adult male in New York City, complained of hallucinations that “commanded” him to kill, he was put on a waiting list, and subsequently shoved an innocent young woman into the path of an oncoming subway train.

Regarding coordination of care, PINs often receive simultaneous services from multiple caregivers who do not communicate with each other and whose services may be redundant or conflicting. In addition, coordination between the PIN, the PINs parents, guardians, and multiple caregivers is often inadequate.

### SUMMARY OF THE INVENTION

The present invention—the Web-Based Clinical, Cross-Organizational Management Information System & Method for Persons In Need Of Supervision—is designed to enhance public safety; significantly improve the standard of care of Persons In Need of Supervision above contemporary practice; and retain these individuals in their own homes, schools, work sites, and communities without hospitalization, institutionalization, imprisonment, or residential detention. This invention is accomplished by integrating the following system functions in a single Internet accessible interface to support communication between all caregivers involved with a specific Persons In Need of Supervision. Moreover, the computer-based system of the present invention provides a methodology of access for centralizing and coordinating the reporting, identification, and treatment referrals of Persons In Need of Supervision.

System functions. The System accomplishes its objective by integrating multiple functions:

1. Strategic Planning

2. Data Security and Privacy

3. Identification and Treatment Referral

4. Assessment

5. Prediction

6. Treatment Design and Matching

7. Behavior Contracting, Case Management, and Tracking

8. Alert

9. Program Evaluation and Failure Analysis

10. Data Archive

11. Reporting

### DESCRIPTION OF THE DRAWINGS

Other features and advantages of the present invention or System—the Web-Based Clinical, Cross-Organizational Management Information System for Persons In Need Of Supervision—will become apparent from the following detailed description of the preferred embodiment when read in conjunction with the following drawings of which:

FIG. 1 is a schematic diagram of the System's N-tier hardware and software architecture.

FIG. 2 is a flow diagram of the overall System's functionality, illustrating the interrelationships of Alert, Behavioral Contracting, and other System functions.

FIG. 3 is a flow diagram of the methodology of the Referral Function.

FIG. 4 is a flow diagram of the methodology of the Behavioral Contracting Function.

FIG. 5 is a flow diagram of the methodology of the Alert Function.

These drawings are described in the body of this application.

### DESCRIPTION OF PREFERRED EMBODIMENT

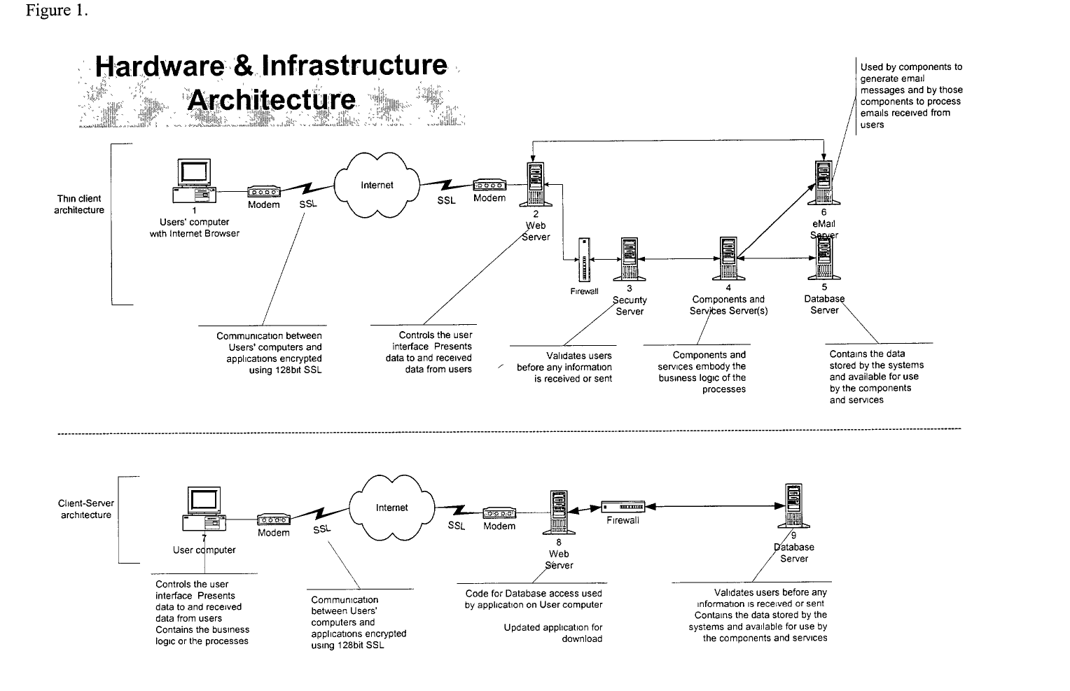

The System can be built using a variety of different N-tier hardware and software architecture as shown in FIG. 1. N-tier refers to the fact to the various infrastructure components are implemented separately. Two approaches are shown in the Figureure. One a thin client and the second using a more traditional client-server model. The tiers envisioned in this system included a web server (e.g., Microsoft Internet Information Server; IIS), a security server (e.g., Microsoft Active Directory Server; ADS), a Components and Services server (e.g., Microsoft Windows 2000 server or Microsoft NET server), a database server (e.g., Microsoft SQL server, Oracle 9i database server), and an email server (e.g., Microsoft Exchange Server). There are various approaches one could take in implementing the ideas contained in this application. Two are shown, above and below the doted line, as examples in FIG. 1.

The top diagram uses a thin client model.

1) In this model the user's computer [1] has only a browser (e.g., Internet Explorer or Netscape Navigator). The user accesses the internet using a 128 bit SSL (Single Socket Layer) connection which provides for encryption from the user's machine to the system's software.

2) The user connects to the web server [2] (e.g., Internet Information Server, Apache Web server) which operates the user interface. That is, what the user sees and the way it is displayed is controlled by this computer.

3) Users enter their ID and password which is passed from the web server [2] to the security server [3]. If correct the user's security roles are read and the individual is ready to use the system.

4) Once validated, users access, enter, and edit the information they need. These various information requests are entered into the interface on the web server [1] and passed to the components and services server [4] which take those requests and combine them with the business logic. Should data be required (either to be read or written) the components and services server formulates the appropriate requests and read or send information from/to the database server [5]. The results are then passed to the user using the web server [2].

5) The toolbox uses email to request and receive information from its users. The email server [6] processes those messages sending out requests for information and receiving responses. The components and services server [4] makes the initial requests and reads and interprets the responses.

With this model all of the work are done on the various servers. The user's computer uses its browser as a window into those processes. In the client server model, at the bottom of the page, the user's computer takes on more of the computing burden.

The bottom diagram of FIG. 1 uses a client server model.

1) The client computer [7] contains the user interface and the basic logic of the application. When a user starts this system a user ID and password are entered and sent over the internet, using 128 bit SSL, to the web server [8].

2) The web server [8] contains the instructions for translating between the user's computer [7] and the database backend [9]. In the case of this initial user ID/password validation it take the information passed by the user and moves it to the database server for validation. If it matches the user would be granted access to the information to which they were entitled.

3) Information is entered into the user's computer [7] and temporally maintained there until the user saves it to the database server [9]. This approach places less burden on the various servers because they do little processing. Their primary function is to send and receive information.

Each tier can also be expanded by enhancing the capabilities of the servers in use (e.g., more memory, additional processors, more storage capability, more efficient versions of software) or by installing additional servers. Information is communicated through the System as shown in FIG. 1. Users enter the System via any standard browsers capable of conducting 128 bit SSL communications. Passing information through the firewall, the user logon and password are checked by the security server. Authorized Users are assigned Role Definitions that permit other servers to select and filter information.

Once validated by the System the users communicate with the system using 128-bit Secure Socket Layer (SSL) connection. This encrypts all of the to and fro communications protecting the information being exchanged from eavesdroppers.

Authorized Users request desired information by, for example, entering a search word, clicking a hyperlink, or selecting an item from a list. That request is sent from the web server to the middle tier components and services server where it is translated into an request for information from the database server. The data request uses SQL to query the database that returns the desired data. Within the Components and Services server, that table is converted into an accessible format before being passed back to the Web server that renders the code into HTML for display on the Authorized User's browser.

The System of the present invention is a flexible computerized multi-component system which through the N tier and web services structural platform architecture provides different functionality's which permits psychological assessments, goal setting, goal tracking, program evaluation, prediction, failure analysis, and after-action analysis. The System uses various databases of information including information about the group subscriber, clients who are the group subscriber's clients, and caregivers employed by or associated with the group subscriber or the client.

System Flexibility

The System is designed to be responsive to changes over time in Subscribers', Authorized Users', and Clients' needs. With the System, Group and Individual Subscriber are free to decide what information and services they need along with their preferred methods of usage.

The System includes diverse, integrated functions from which Group or Individual Subscribers may choose. Some functions are necessary to the basic Group or Individual Subscription.

For Group Subscribers, a necessary System function is the methodology of entry and storage in a Client Database of basic information about all Clients and about all Caregivers. Basic information for a client includes typical identifying information (e.g., name, sex, identification numbers) as well as information about the identity of individual Caregivers who are Authorized Users of the clients information. Authorized Users could include the client's family members or guardians, their Lead Caregiver, and the other members of their Caregiver Team. The information for each of a client's Authorized Users also includes their client specific Role Definitions which defines the level and types of information available to them (i.e., their security clearance).

Group Subscribers may choose to augment the information that is routinely entered into the Client Database, the Caregiver Database, or the Management Database. The Group Subscriber may choose to augment information in these databases in order to satisfy short-term reporting requirements (e.g., adding information about gross family income to records in the Client Database). Information augmentation may also prepare the Group Subscriber to employ supplementary System functions such as program evaluation (e.g., determining the impact of System use on clients' with low, medium, or high gross family incomes). A Group Subscriber may choose to augment information in the Client and Caregiver Databases in order to track the accountability of various Caregivers and in order to evaluate the impact of low, medium, and high Caregiver accountability on Client outcome such as rearrest and hospitalization. A Group Subscriber may choose to enter in the Client Database, information about each Client's complete history of Treatment Episodes. A Treatment Episode represents a period of time during which the Client receives care, supervision, or treatment by a Caregiver Team. Aided by the System's Program Evaluation Function, complete Treatment Episode information permits a Group Subscriber to ascertain what type of care, administered by what type of caregivers, works best for which types of clients.

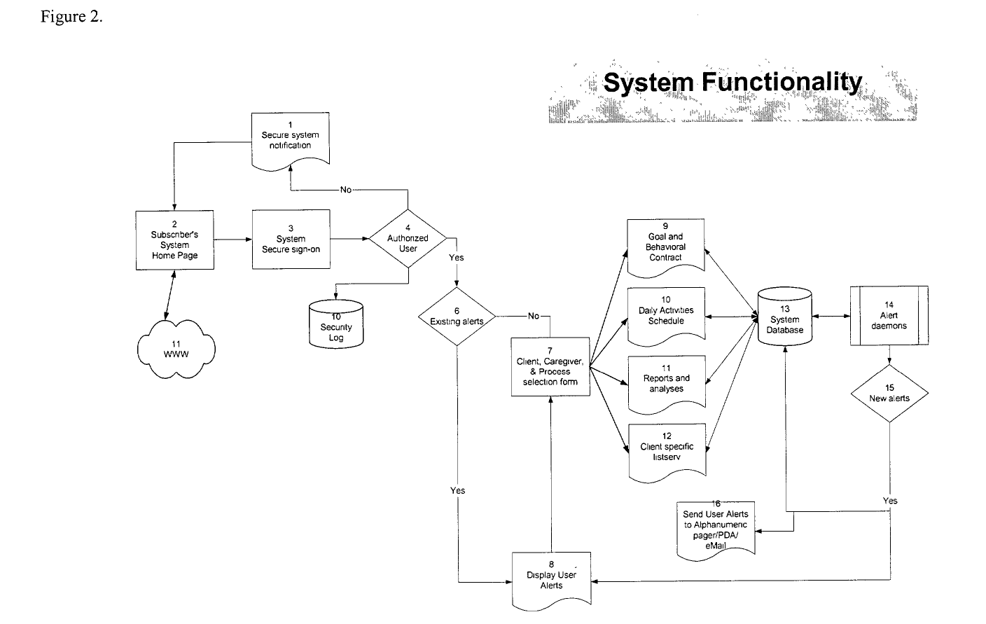

The flexibility of the system is supported by its over all functionality as shown in FIG. 2.

1) The first part of the system functionality diagram describes the user's gaining access to the data by supplying a valid user ID/password combination [2, 3, 4, 1, and 10].

2) Once in the system users see any active alerts to remind them of activities for which they are responsible or to alert them to problems with any of their clients [6].

3) Validated users can create and change goals and behavioral contracts [9], modify and report on clients' daily activity schedule [10], view and print various repots and analyses of data from individual clients [11], caregivers, or various groupings of the same. Additionally, users can correspond electronically with all of the caregivers involved in a particular client' case using email and listservs [12].

4) All of the actions of users are stored in the system database [13].

5) The Alert daemons [14] review the information entered and send alerts [15] to the caregivers' computer monitor [8] and email [16] to remind them of activities for which they are responsible or to alert them to problems with any of their clients.

1. Strategic Planning Function

During initiation of a Group Subscription, executives and managers of the Caregiver Alliance access the Strategic Planning Function. This function facilitates establishment of procedural or business rules for operation of the System in a manner that achieves the goals of the Alliance. For example, using this function, Caregiver Alliance executives concerned about school safety, establish the procedures for collaborative response to an anonymous threat of school violence. Or, using this function, Caregiver Alliance executives concerned about corporate safety, establish the procedures for supervising employees who have been the subject of coworker complaints about harassment.

2. Data Security and Privacy Function

The System provides for both data security and privacy while making information available to Authorized Users. All the System's security and privacy components are compliant with applicable federal regulations (e.g., HIPAA).

Data security is maintained through daily backup of all information and off site storage of data. Locks, passwords, and tokens protect physical access to the servers. UPSs, surge protectors, and back-up power generators protect all servers from electrical problems. Other available security options include rollover servers and redundant hosting at multiple sites.

All communications are conducted via a Secure Sockets Layer (SSL) employing 128-bit encryption. This is the most secure encryption allowed by law. With this technology, information passed over the public Internet between users' computers and the System is safe from eavesdropping and decryption. This level of encryption is supported in standard browsers like Internet Explorer (Version 5 and higher) and Netscape (Version 4 and higher), on Web access devices such as WebTV, I-Opener, and Dot.Station, by handheld computers such as those based on the Palm, Window CE, or Linux operating systems, and on mobile phones or 2-way pagers.

Generally, to gain access to System information, Authorized Users must logon with their user name and password. Some functions (e.g., the emergency override described below) may require additional verification with a token (i.e., ID card) or biometric device (e.g., fingerprint or retinal scan). If verified by the Security Server, Authorized Users gain access to various components of the System and Client data based on their Role Definitions. For example, an Authorized User with the Role Definition of validator may only update information relating to a particular goal and read information related to a Client's goal-related progress. Validators are neither permitted to review assessment information nor to add additional goals. An Authorized User with a Role Definition of Lead Caregiver, has a broader level of access to a Client's information. Authorized Lead Caregivers may complete assessments, add additional goals, create relationships between the Client and Caregiver Team Members, and so on. Most Authorized Users may see information about Clients only if they have a defined relationship with a specific Client (e.g., relative, therapist, religious leader) or a defined relationship with a Caregiver Team Member (e.g., the Authorized User is the officially designated supervisor of the Lead Caregiver). Thus, for example, a Group Subscriber may have 600 Clients in its client database, while each Lead Caregiver has access to information on only the 20 of those Clients for whom they are specifically responsible.

For particularly sensitive data including information about substance abuse services, HIV status, and sex crimes, the Authorized User must have additional clearance for access or entry. Without such clearance, Authorized Users see only the statement “protected activity.”

Some Group Subscriber represent networks or alliances of caregiver organizations, agencies, and systems, hereinafter referred to as a Caregiver Alliance. For a Caregiver Alliance, information on the Clients of each Alliance Member is stored so that is ordinarily not accessible to any other Alliance Member. Information becomes accessible to other Alliance Members, only when a Client provides a signed release of information authorizing such access.

The System's numerous security and privacy considerations combine to offer a HIPAA compliant system to which sensitive information can safely be entrusted and which provides Authorized Users with ready access to needed information. For example, one component of HIPAA compliance requires that each time a record is disclosed, information about that disclosure must be recorded and stored. The system accomplishes that task through its design and functionality.

In some situations a security override may be required. That is, people would need to see data, which would not normally be available to them. For example, an individual takes a number of high school students hostage. The hostage negotiators may request the emergency ability to search across all clients in the system for the hostage taker to be able to quickly identify those Caregivers who might help defuse the situation. Though these negotiators would not normally be privy to this information the needs of the situation would outweigh the privacy intrusion. Top-level system administrators, identified by additional token or biometric keys, could grant such access and would also document the nature of the emergency override and the disclosed information.

3. Identification and Treatment Referral Function

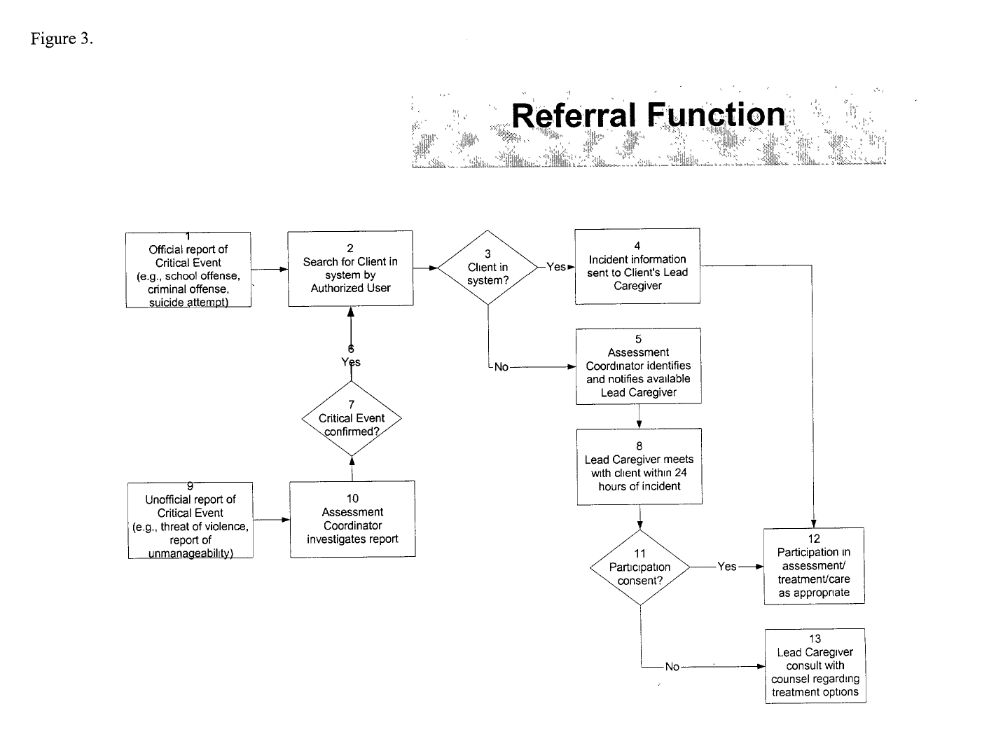

The Identification and Treatment Referral Function of the present invention is illustrated in FIG. 3, which is hereinafter referred to simply as the Referral Function. The Referral Function offers a Web-based method of centralizing and coordinating the reporting, identification, and treatment referrals of Clients within a community, school system, court system, corporation, agency, facility, institution, cross-organization alliance, or treatment network. As the flow diagram of FIG. 3 illustrates the present invention permits rapid reporting of risk related incidents, identification and treatment referral of individuals to an assessment coordinator assigned specifically to act immediately upon receipt of a risk related incident. The Referral Function of the System is accessed by an Authorized User of a Group Subscriber's System Version who gains information about a Risk-Related Incident, hereinafter referred to as an Incident (e.g., threat of violence, threat of suicide, act of violence, suicide attempt, drug overdose, criminal offense, school offense). The Authorized User checks the Group Subscriber's Client Database. If the potential client is in the Client Database, the Authorized User informs the Intervention Coordinator and the Lead Caregiver coordinating the individual's care about the Incident. If the potential PIN is not in the Client Database, the Authorized User informs the Assessment Coordinator who requests informed consent for treatment participation from the client and their parent or guardian. The System of the present invention also permits Public Users (e.g., parent, teacher, neighbor, nurse, pediatrician, therapist) to gain access to the Referral Function by e-mailing through the Internet the appointed Assessment Coordinator, as identified e.g. in the Group Subscribers System Home Page for that local community, about an Incident related to a potential client. In the Figure this is referred to as an “Unofficial Report of Critical Event.”

Within 24 hours of learning about an Incident, the Assessment Coordinator verifies the occurrence and nature of the Incident in a clinically and legally appropriate manner, and updates the Client Database with an new information. After confirming the occurrence of the Incident, if the individual is not in the Client Database, the Assessment Coordinator solicits consent for initiation of supervision or treatment by system caregivers. The Assessment Coordinator solicits informed consent from adult individuals and the parents or guardians of minors as well as the informed assent from minors. If informed consent is granted, the Assessment Coordinator consults the Caregiver Database, selects, and notifies a Lead Caregiver and Caregiver Team Members suitable for coordination of the client's supervision and treatment. The Lead Caregiver immediately arranges a meeting with the client, their parents or guardians, and the Caregiver Team Members. If informed consent is denied, the Assessment Coordinator immediately notifies the System's legal authorities for a determination of a constitutionally sound approach to a potential threat to public safety.

The System's referral tool is shown in FIG. 3 and makes referral of an at-risk youth faster and more effective than it could be without this system. The system allows coordination of the resources of a group of caregiver organizations so that each at-risk youth receives necessary services quickly. Usually, caregiver agencies operate independent intake and referral systems. Some agencies have few treatment slots available while others have many open. The conventional approach to intake and referral can easily result in youths who are genuinely at risk being placed on waiting lists, not receiving needed treatment services, and, as a result, endangering the public safety. The Referral Tool uses electronic methods to substantially improve intake and referral of at-risk youths:

1. A group of caregiver organizations in a community agree to cooperate in referring youths to member organizations. Caregiver organizations might include school system, juvenile justice system, police, community mental health center, social services.

2. For the purpose of cooperative referrals, member organizations appoint round-the-clock assessment coordinators and give authorized members of each agency a password.

3. A client database is set up that include the names of all youths in treatment with member agencies.

4. Via the community's home page, anyone in the community (referral source), at any time, can make a referral of a youth who seems at risk for behavior harmful to self or other such as crime, violence, substance abuse, or suicide [1].

5. At the community's home page, the referral source uses a web-based form to describe the occurrence of a risk-related incident (e.g., school offense, criminal offense, suicide attempt, threat of violence) indicating who was involved in the incident, where and when the incident occurred.

6. If the referral source is a user authorized by the caregiver alliance, the referral source first searches the client database to determine if the youth is already in treatment with a member agency [2].

a. If the youth is in treatment [3], the referral source provides information via email to the lead caregiver in charge of the at-risk youth's treatment [4].

b. If the youth is not in treatment, the referral source notifies the assessment coordinator [5]. The notification is immediate to the on-call assessment coordinator.

7. If the referral source is not an authorized user [9], the referral source contacts the on-call assessment coordinator immediately by e-mail or telephone.

8. Upon receipt of the referral, the assessment coordinator follows the caregiver alliance procedures to confirm the basis for the referral [10]. The methods of confirmation will vary depending upon the nature of the risk-related incident reported.

9. Following confirmation of the basis for the referral, the assessment coordinator uses electronic scheduling to set an appointment for the confirmed at-risk youth with an available lead caregiver from a caregiver alliance member organization [8].

4. Assessment Function

Individual and Group Subscribers use this function for on-line administration, scoring, and interpretation of structured interviews, tests, and measures relevant to the supervision, treatment, and care of clients. Resulting data becomes part of the Client Database.

5. Prediction Function

Group Subscribers use this function to derive actuarial formulas for empirical prediction of risk for various types of Incidents. The Prediction Function makes use of information (without client identifiers) residing in the databases.

6. Treatment Design and Matching Function

Group Subscribers use this function to design an optimal course of treatment for an individual and to match them to available Caregivers and available types of supervision, care, and treatment. This function makes use of statistical models derived via the Prediction Function as well as clinical decision models created for these purposes.

7. Behavioral Contracting, Case Management, and Tracking Function

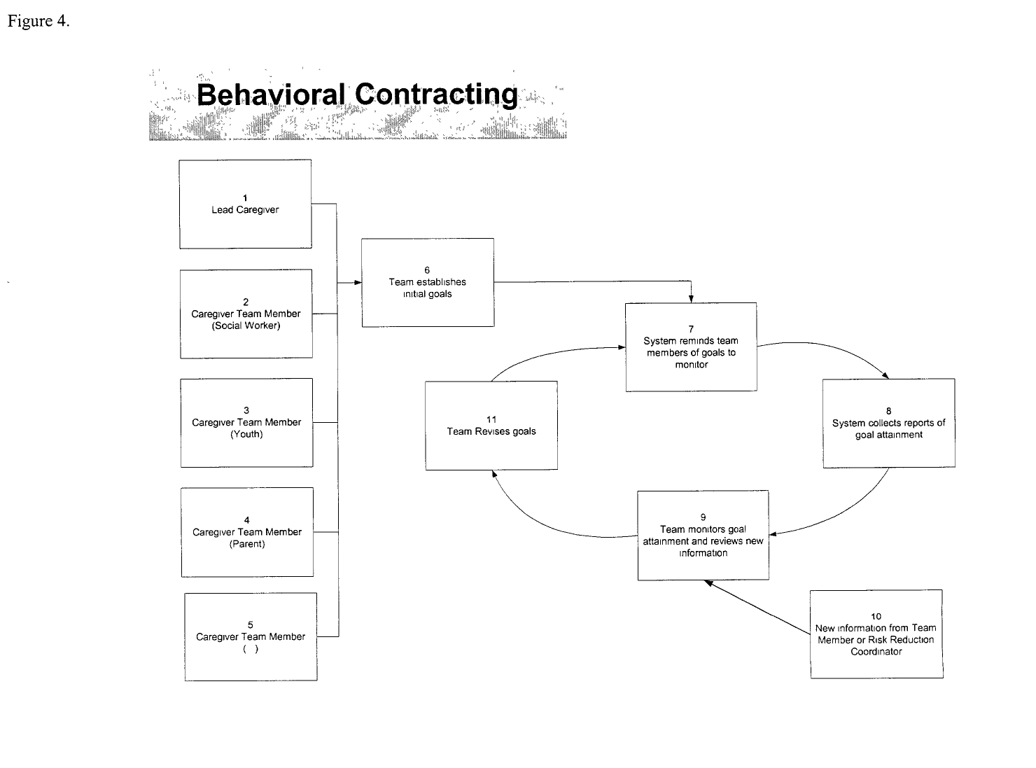

The Behavioral Contracting, Case Management, and Tracking Function, hereinafter referred to as the Behavioral Contracting Function is illustrated in FIG. 4.

The Behavioral contracting tool is a makes development and implementation of a behavioral contract more effective than it could be without this system.

1) All members of a client's caregiver team [1, 2, 4, 5], including the client [3], can make suggestions for the appropriate goals to be included in the plan. These goals are described in objective behavioral terms (e.g., attend school 5 days a week) [6].

2) The caregivers select individuals, from their group, to monitor each of the selected goals and to report on the client's goal related progress.

3) The Toolbox electronically reminds caregivers of their monitoring responsibilities on the day they should be made [7]. Caregivers reply to those requests feeding information on client goal attainment back to the system and other caregivers [8].

4) Various reports are generated to help the caregiver team monitor a client's progress [9]. Should it be so indicated those team members can use that information to restructure the goals [11].

5) Additional information also enters the system when the risk reduction coordinator enters critical events about an individual [10]. As above, this information is used to monitor and change plans appropriately [9].

The client's Lead Caregiver accesses this function to manage the client's care, and to prevent repeated or new Risk-Related Incidents. The Lead Caregiver uses this function to facilitate formulation of the basic elements of a behavioral contract with input from the client, the client's parents or guardians, and Caregiver Team Members. The contract specifies the client's behavioral goals and or the client's daily activity schedule. While the former focuses on broad goals (e.g., daily on-time school attendance), the latter provides a very specific schedule for the individual 24 hours a day, 7 days a week (e.g., attend school from 8 am to 3 pm Monday through Friday, participate in after school tutoring 3 pm to 4:30 pm Monday, Wednesday, and Friday, attend recreation center after school supervised program 3 pm to 6 pm Tuesday and Thursday). The contract also specifies incentives provided to the client contingent upon goal attainment and or schedule adherence. Finally, the contract specifies the reporting and other contract-related responsibilities of Caregiver Team Members (e.g., probation officer meets with client for an hour a month and reports about the results of randomly scheduled drug urine tests).

The system uses these goals and activities to help Caregivers coordinate and manage multiple activities. As part the above described behavioral contract the system keeps track of what should be occurring when. When items are due the System alerts (via email, pager, or text enabled cell phone) those responsible for activity monitoring asking them for feedback on client participation.

The system monitors returning email searching for replies to these reminders. When they arrive, it alerts the caregiver and makes it easy for them to read and act on the returned information. If a timely reply does not arrive, the System alerts the user making it easy for them to follow-up with the reporter to motivate and collect their response. This process provides an ongoing record of client and Caregiver activities and responses to treatment. The following are two simplified examples of the system methodology of the present invention for providing reminders:

### EXAMPLE 1

Caregiver team (including client) is working with a young woman who has been getting into trouble with the authorities for shoplifting. This behavior is most frequent during the day when she cuts school. To decrease her risk for engaging in that activity during that time period the team creates a goal “attend school 5 days a week.” The Assistant Principal, who is a member of the team is selected to monitor that goal every Friday. The Toolbox reviews the activities that are due each day. On Friday it sees that this report is due and automatically sends a message to the Assistant Principal asking if the client has been in school for the past 5 days. The Assistant Principal responds “Yes,” via email or web site, which is recorded in the database. Information from many such goals, individuals, and caregivers is later combined into reports to help caregivers monitor and adjust the goals.

### EXAMPLE 2

An elderly woman lives in her own home in Cleveland. Her children live in Louisville and Oakland and want to be keep up with her. Her children set up a caregiver team that includes themselves, their mother's minister, the owner of the local market where their mother shops every Thursday, and her hair dresser. The goals are set so that mother attends church on Sunday (to be verified by her minister), markets on Thursday (to be verified by the market owner), and gets her hair done on Saturday (to be verified by her hair dresser). Each week, on the appointed day the Toolbox sends a message to the responsible caregiver asking is mother attended the activity and if she was OK. They respond, via email or web site, with her status. This information is summarized an always accessible to her children who can now keep closer tabs on their mother's ability to continue to live independently.

The client and the Caregiver Team has continuous access to reports summarizing the client's progress over time in adhering to the contract, as well as incentives earned for contract adherence. After inspecting these reports, the Lead Caregiver may recommend various modifications in the client's treatment plan, changes in the composition of the Caregiver Team, or the end of client supervision, treatment, and care.

8. Alert Function

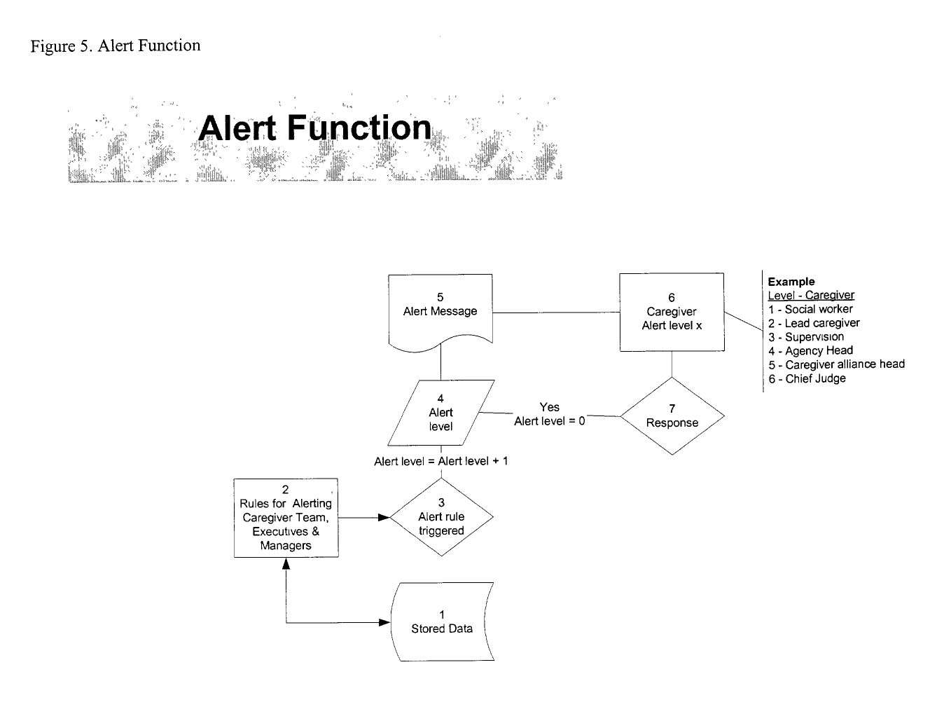

The Alert Function illustrated in FIG. 5 draws on information derived from the Referral and Behavioral Contracting Functions.

The Alert function deal with the question of getting information to users so that situations in need of supervisory attention receive that attention. Using this method helps make sure that events, and individual clients, do not fall through the cracks and get forgotten.

The Alert Function pushes alarms up the Group Subscriber's hierarchy of Authorized Users whenever there is an indication that a Risk-Related Incident may occur or reoccur due to the action or inaction of a PIN, a Caregiver, or an Authorized System User. The alarm continues to travel up the hierarchy until an appropriate agent of the Group Subscriber turns the alarm off by entering information about an appropriate action.

1) Rules for triggering alerts are stored in the database. As an alert is triggered it is given an initial level of 1 and a message is sent to the appropriate level of caregiver. For example he first level shown on the diagram would be the client's social worker.

2) If the caregiver responds the alert is cleared. If they do not respond after a specified period of time the alert level would be increased by one and it would be sent to the next level of caregiver. In the diagram this would be the client's lead caregiver, the person responsible for orchestrating the clients care.

3) Each time the alert is not cleared within a specified time frame it is resent to a higher and higher level of staff until it is taken care of.

9. Program Evaluation and Failure Analysis Function

Group Subscribers use this function for prospective evaluation of program effectiveness and for analysis of system failures following a Risk-Related Incident involving school or workplace violence. Group Subscribers can use the results of this function to refine their strategic plans. This function draws upon information residing in Client, Caregiver, and Management Databases.

10. Data Archive Function

Individual subscribers use this function to store PIN related records in a secure manner and to access records for distribution to caregivers.

11. Reporting Function

Group Subscribers uses this function to generate clinical and management reports.

What we claim is:

1- A method of centralizing and coordinating treatment referrals for persons in need of supervision and/or under the current supervision of a caregiver in a member alliance of caregiver agency organizations comprising the steps of:
forming a centralized database on the world wide web for storing a list of specified persons currently in treatment by a caregiver affiliated with said member alliance and other information and data relative to each such person;
authorizing users affiliated with said member alliance to access the centralized database through a browser when an incident occurs which is reported to said authorized user either by an official report, unofficial report or from a referral source involving a person who may be on said list or who may not be on said list but may otherwise be in need of supervision and/or treatment based upon such incident;
having the authorized user check the centralized database to determine if such person is on the list and for immediately informing the appropriate caregiver and/or caregiver agency caring for such person of the occurrence of such incident when such person is on the list or for providing such information to an assessment coordinator to obtain consent for the referral and/or treatment of such person by a caregiver in said member alliance and upon receipt of such consent and updating such list to include such person.

2- A method as defined in claim 1 wherein said incident may be reported officially to an authorized user of the occurrence of an incident defining a critical event for immediate action or unofficially from any source to an assessment coordinator for confirmation that the incident is a critical event requiring submission to an authorized user.

3- A method as defined in claim 2 further comprising the steps of;
specifying selected goals representing objective behavior for persons on the list currently under supervision and having a reminder for each goal automatically generated for electronic submission to the appropriate selected authorized user having the responsibility of monitoring the goal to determine if the goal has been met by the person under supervision.

4- A method as defined in claim 3 further comprising the step of automatically checking to see if a report has been generated in response to the reminder and to determine if the goal has reached or not.

5- A method as defined in claim 4 further comprising the step of generating a first alert alarm if a report has not been generated and a second alert alarm when a goal has not been reached for further supervisory attention.

6- A method as defined in claim 3 further comprising the step of updating the centralized database with information relative to the performance of the person in meeting a goal.

7- A web based cross organizational management information system for centralizing and coordinating treatment referrals for persons in need of supervision and/or under the current supervision of a caregiver in a member alliance of caregiver agency organizations via the internet comprising:
a centralized database for storing a list of specified persons currently in treatment by a caregiver affiliated with said member alliance and other information and data relative to each such person;
a web server for controlling the interface with authorized users of the system affiliated with said member alliance and for screening the PIN numbers of said authorized users before approving access to the system;
communication means through which said authorized users communicate to said web server;
toolbox means for requesting and receiving information from said authorized users with said toolbox means including means for generating an informational reminder to a selected authorized user to remind such user to carry out a specific function and to update the centralized database with a report; and
an e-mail server for processing and sending an e-mail message to said selected authorized user corresponding to said informational reminders.
